(19) United States
(12) Patent Application Publication
(10) Pub. No.: US 2023/0010036 A1
(43) Pub. Date: Jan. 12, 2023

(54) Utility Vehicle Tie Rail

(71) Applicant: Matthew Hildreth, Cranbourne Vic (AU)

(72) Inventor: Matthew Hildreth, Cranbourne Vic (AU)

(21) Appl. No.: 17/857,601

(22) Filed: Jul. 5, 2022

(30) Foreign Application Priority Data
Jul. 6, 2021 (AU) 2021902051

(51) Int. Cl. B60P 7/08

(52) U.S. Cl. CPC B60P 7/0815

(57) ABSTRACT

A tie rail 100 for a utility vehicle having a tray with at least a first wall 3. The first wall 3 is adapted to extend substantially in a first plane 4 (see FIG. 1A). The first wall 3 of a typical utility vehicle 1 may have a first outer edge 5 defining an internal recess 6. The tie rail 100 includes a first member 110 that is substantially rigid and strong, elongate and continuous. When mounted on the first wall 3, the first member 110 is spaced from and extends substantially parallel to the first plane 4 and the first outer edge 5. The tie rail 100 also has at least two anchor sections 120 extending transversely to a longitudinal axis 112 (see FIG. 2C) of the first member 110. The anchor sections 120 are generally adapted to be vertically aligned in installation and include at least two spaced anchor points 122. Each anchor section 120 and each pair of anchor points 122 are each adapted to align with one of the vehicle structural substrates 7. The anchor sections 120 are preferably formed as a continuous unitary piece with the first member 110. The anchor sections 120 each include an outer anchor point 126 at or near the outer end 124. The outer anchor point 126 is spaced from both the first member 110 and an internal anchor point 114 located on or in the first member 110.

### PRIORITY CLAIM

This application is a Convention Application for a complete or utility patent application claiming priority under 35 U.S.C. § 119(a), from Australian Provisional Patent Application No. 2021902051 filed Jul. 6, 2021, titled “Utility Vehicle Tie Rail,” the entirety of which is hereby incorporated by reference.

### FIELD OF INVENTION

This invention relates to a utility vehicle tie rail. More particularly, this invention relates to a utility vehicle tie rail mounted to an inside wall of a utility vehicle tray.

### BACKGROUND ART

The following references to and descriptions of prior proposals or products are not intended to be, and are not to be construed as, statements or admissions of common general knowledge in the art. In particular, the following prior art discussion does not relate to what is commonly or well known by the person skilled in the art, but assists in the understanding of the inventive step of the present invention of which the identification of pertinent prior art proposals is but one part.

Utility vehicle tie rails have been described in which a tie rail comprising a metal rod is spaced from a side wall or side edge to allow ropes, hooks and straps to be attached to a section thereof to tie down a load in or on the tray and is welded or bolted to a suitable strong and rigid substrate on the vehicle. Utility vehicle tie rails are generally positioned proud or beyond an edge of a wall or other extremity of the vehicle and present unaesthetic snag and injury hazards and often protrude into the usable space of the utility vehicle.

One of the disadvantages of the prior art is with respect to the working load limit (WLL) or the safe working load (SWL). Applicant has found that typically suppliers and manufacturers of prior art devices only give a breaking strain of the product in isolation and do not take into account the strength of the rail when fastened to the utility tray. A breaking strain is not a WLL or SWL. At breaking point, the rail component has already exceeded its yield strength and is damaged and weakened for future use. Applicant notes that where suppliers and manufacturers of the prior art devices list these breaking strains, the information may not be an accurate representation of the WLL or SWL regarding the load that can be safely secured. In contrast, Applicant has the load rated by an engineer specific to each model utility in which a utility vehicle tie rail according to the invention as installed.

An object of the present invention is to ameliorate the aforementioned disadvantages of the prior art or to at least provide a useful alternative thereto.

### STATEMENT OF INVENTION

The invention according to one or more aspects is as defined in the independent claims. Some optional and/or preferred features of the invention are defined in the dependent claims.

Accordingly, in one aspect of the invention there is provided a tie rail assembly, namely:
A tie rail for a utility vehicle having a tray with at least a first wall, the first wall:
   i. being adapted to extend substantially in a first plane;
   ii. having a first outer edge defining an internal recess; and
   ii. having at least two vehicle structural substrates adapted to extend substantially transversely to the first outer edge,
the tie rail comprising:
   A. a substantially rigid and strong elongate and continuous first member on which items may be tied, the first member being spaced from and extending substantially parallel to the first plane and the first outer edge;
   B. at least two anchor sections extending transversely to a longitudinal axis of the first member, the anchor sections:
      i. each being adapted to align with a vehicle structural substrate;
      ii. are formed as a continuous unitary piece with the first member;
      iii. have an outer end remote from the first member that is adapted to be received by the internal recess;
      iv. include an outer anchor point at or near the outer end, the outer anchor point being spaced from both:
         the first member; and
         an internal anchor point located on or in the first member; and
   C. an end member that is broader in shape, compared to the anchor sections, along the first plane and accommodates one or more end anchor points.

### Vehicle, Tray and First Side Wall

The vehicle is a utility vehicle of the type being light commercial or industrial road-going automobile, including an electric or hybrid fuel vehicle, preferably having a front cabin for passengers and a rear tray.

The tray typically has a flat bed that is flanked by a pair of spaced side walls, wherein the at least first wall is in the form of one of the side walls.

Such utility vehicle side walls typically include a substantially flat and planar panel (including a side wall panel that is aesthetically contoured in the manner of a modern vehicle).

The first outer edge may be in the form of an upper edge of the panel that is folded inwardly to achieve an over-hung upper edge. The over-hang may define the internal recess that has an opening facing downward toward a floor of the tray.

The vehicle structural substrate may be the panel of the first side wall, where the panel is metal and of sufficient strength and rigidity whereby to provide a suitable substrate for anchoring the tie rail to the vehicle. Alternatively and preferably, the vehicle structural substrate is in the form of a plurality of structural pillars. The or each vehicle structural substrate may generally extend in a vertical orientation between the floor and the first outer edge.

The first side wall may include a wheel arch. The tie rail may be installed above the wheel arch.

### First Member

The first member is advantageously formed as a unitary piece with the anchor sections and the end member.

The first member could be welded to the anchor sections and the end member.

However, preferably the first member, the anchor sections and the end member form part of the same unitary piece. The first member, the anchor sections and the end member may be manufactured by moulding, casting, stamping, laser-cutting or other means. Each transition zone between (i) the first member and the anchor sections; and (ii) the first member and the end member, is continuous material. Preferably therefore, the first member, the anchor sections and the end member are made from and of the same material.

The material of the first member, the anchor sections and the end member is preferably Aluminium, hardened steel, marine grade steel, coated metal or galvanised steel. However, the material may comprise a composite of metal and plastic, or a high strength plastic such as acetal, optionally with a metal reinforcing core. Advantageously, the first member is made of a strong and rigid metal that is inherently corrosion-resistant or coated for protection.

The first member may be in the form of a rigid ribbon, strap or plate. The first member may be cut out, stamped, cast or moulded into an elongate member. The first member may be a rod, solid or rectangular/circular or other cross-sectioned shaped hollow section. The first member may be plate-like. The first member may form part of a plate. The first member may be formed as part of a section of a panel, optionally stamped, laser or mechanically cut to shape.

The first member may be in the form of an outer guard of the tie rail.

### Second Member Forming Truss

The tie rail may further include a second member. The second member is preferably adapted to strengthen the first member. The second member is preferably adapted to assist in evenly distributing load applied at various tie points or sections along a length of the first member. The second member is preferably elongate, and spaced and extends substantially parallel to the first member.

The second member preferably forms a truss with the first member and the anchor sections. Preferably, the truss comprising the first and second members, and the anchors sections, is integrally formed together at manufacture as a unitary piece. Preferably, the truss is formed from the same material or a composite such as a metal skeleton over-moulded with high wear-resistant polymer material.

The anchor sections may be in the form of struts forming a web between the first and second members.

### Separate Brace

The first member may be used without being combined with the reinforcing member which together may form a truss. The first member may simply be bolted through a spacer and the inner wall of the utility vehicle tray with a mudguard washer and nut behind. Although the first member is strong within itself and useful for lower load applications, the load rating can be improved to suit higher load applications. “Load” in this context refers to the force applied to a particular section of the first member acting as the elongate member of the tie rail to which a tie is attached in use. A stronger tie rail with a higher load rating can be achieved by adding the reinforcing member to the tie rail assembly.

Therefore, the tie rail may further include a reinforcing member. The reinforcing member may be in the form of a brace. The reinforcing member is preferably formed from a piece that is separate to the first member. The reinforcing member is preferably adapted to assist in evenly distributing load applied at various tie points or sections along a length of the first member. The reinforcing member is preferably elongate, and spaced from, and extends substantially parallel to, the first member. The reinforcing member may be coextensive with the length of the first member. However, the reinforcing member preferably extends partially along the length of the first member. The reinforcing member is preferably co-terminal with at least one end of the first member.

The reinforcing member is preferably attached to the first member by rigid fasteners. The rigid fasteners may extend through pairs of registered apertures aligned in the first member and the reinforcing member. The reinforcing member may be fixed in place between an inner surface of the first wall and the first member. The fasteners may be bolts. Between the first member and the reinforcing member may be one or more spacers that space the reinforcing member from the first member. The fasteners may extend through the spacers, which may be in the form of metal blocks or other material capable of resisting compressive forces.

The fasteners may be in the form of rail mounting bolts that extend through the first member or rail. The fasteners may extend through a spacer and the first wall of the of the utility tray, into the reinforcing member that is in the form of a lateral brace. At this location where the fasteners extend through the first wall, the inner surface of the first wall preferably corresponds to the vehicle structural substrate which is preferably in the form of a wall pillar or folded sheet metal strengthening rib formed in the first wall.

The reinforcing member greatly increases the load capacity of the first member. Without the reinforcing member, the tie rail’s strength is mostly within the first member and derives very little strength from the inner wall of the first wall. When the first member is rigidly fastened to the reinforcing member, the truss is formed to increase the strength of the tie rail and its achievable load rating.

The reinforcing member adds strength and spreads more of the point load that may be applied, for example by a tie down strap, to the first member or the tie rail in general. The load may be distributed to adjacent and next-adjacent anchor points along the length of the reinforcing member.

The length of the reinforcing member may vary depending the model of utility vehicle for which it is designed. The reinforcing member is preferably made as long as possible whereby to overlap with as many anchor points as possible to provide a maximum load capacity.

In terms of ease of installation of the tie rail assembly, the installation of mudguard washers and an associated nut onto a fastener, such as a bolt, for attaching the assembly to the first side wall can be extremely difficult, particularly in the location above the wheel arch. The reinforcing member is not only advantageous to improve the strength of the tie rail, but also assists in installation as it can be handled from one end of the reinforcing member to position the other end in the location below the first outer edge and above the wheel arch.

### Anchor Sections

The anchor sections preferably extend from the first member to a location laterally spaced from the first member. The anchor sections are preferably located at the ends of the first member. The anchor sections are still more preferably located intermediate the length of the first member.

Each anchor sections may have a first anchor point that is provided at the location of the transition zone where the first member transitions to the anchor section. Each anchor section may have a second anchor point laterally spaced from the first member and located at or close to an end of the anchor section remote from the first member.

Where the tie rail does not have a second member, each anchor section is preferably an arm. The arm preferably extends normal to the first member.

Where the tie rail does have a second member, each anchor section is preferably a strut or web spanning between and joining as a bridge, the first and second members. Where the tie rail is formed in part from a stamped or cut sheet or plate, the anchor sections may be defined by a continuous section of material extending laterally between the transition zone between the first member and the anchor section, and the remote anchor point spaced from the first member. The anchor section may be defined by cut outs or holes that, with the transition zones, delimit in part the upper boundary of the first member.

The tie rail may therefore take the form of the plate with cutouts. The plate may include: (a) the first member in the form of a horizontal bar or rail; and (b) the anchor points in the form of vertical arms which may be defined between holes through which a tie down may be hooked or attached. The horizontal rail may be formed by the cutouts themselves or by a round bar or pipe fabricated to the plate.

### End Member

The end member may be in the form of a head section that is broader than the first member in a direction transverse to the longitudinal axis of the first member. The end member may include two or more end anchor points that are spaced from each other in the direction of the longitudinal axis. The end member preferably includes at least one, and preferably at least two, anchor points. The end member may be a frontmost member of the tie rail.

The tie rail may further include a second end member. The second end member may be at adapted to be positioned at a rearmost terminal end of the tie rail. The second end member may be of similar or the same dimensions as the anchor section extending from the upper side of the first member. The second end member may include a downwardly extending flange adapted to be positioned below the first member. The second end member preferably includes at least one, and preferably at least two, anchor points.

In another aspect, the same invention provides:

A tie rail mount for a utility vehicle having a tray and side walls and adapted to extend in a main plane, the tie rail mount comprising:
a broad front end bracket;
a bar extending substantially the full length of the tie rail mount;
a plurality of spaced vertical arms located intermediate the length of the bar,
anchor or fastener points at top and/or bottom of each end bracket and each vertical arm;
wherein:
the vertical arms extend normal to the bar in the main plane;
the vertical arms are spaced to correspond to wall posts of ute tray side wall;
the vertical arms extend on the same side of the bar;
the bar is adapted to extend between tray wall posts of the utility vehicle so that there is a gap between the bar and the internal surface of the utility vehicle side wall for ties to be inserted or wrapped-around the bar;
the vertical arms number two or more;
the tie rail mount comprises a lateral tie rail that is adapted to extend laterally into an interior of the utility vehicle tray transverse to the main plane; and
a rail longitudinal axis of the lateral tie rail is substantially parallel to, and be spaced from, a bar longitudinal axis of the bar.

### BRIEF DESCRIPTION OF THE DRAWINGS

The invention may be better understood from the following non-limiting description of preferred embodiments, in which:

FIG. 1A is a isometric view of a tie rail according to a first embodiment shown mounted to an internal side of a tray side wall of a utility vehicle;

FIG. 1B is a front view of the tie rail according to the first embodiment;

FIG. 1C is a sectional view A-A from FIG. 1B;

FIG. 1D is an expanded view of portion F from FIG. 1C;

FIG. 2A is an isometric front view of a tie rail according to a second embodiment;

FIG. 2B is another isometric front view of a tie rail according to the second embodiment;

FIG. 2C is a top plan view of the tie rail shown in FIG. 2A;

FIG. 2D is a front elevatory view of the tie rail shown in FIG. 2A;

FIG. 3A is an isometric front view of a tie rail according to a third embodiment;

FIG. 3B is a top plan view of the tie rail shown in FIG. 3A;

FIG. 3C is a front elevatory view of the tie rail shown in FIG. 3A;

FIG. 4A is an isometric front view of a tie rail according to a fourth embodiment;

FIG. 4B is a top plan view of the tie rail shown in FIG. 4A;

FIG. 4C is a front elevatory view of the tie rail shown in FIG. 4A;

FIG. 5A is an isometric front view of a tie rail according to a fifth embodiment;

FIG. 5B is a top plan view of the tie rail shown in FIG. 5A;

FIG. 5C is a front elevatory view of the tie rail shown in FIG. 5A;

FIG. 6A is an isometric front view of a tie rail according to a sixth embodiment;

FIG. 6B is a top plan view of the tie rail shown in FIG. 6A; and

FIG. 6C is a front elevatory view of the tie rail shown in FIG. 6B.

### DETAILED DESCRIPTION OF THE DRAWINGS

Preferred features of the present invention will now be described with particular reference to the accompanying drawings. However, it is to be understood that the features illustrated in and described with reference to the drawings are not to be construed as limiting on the scope of the invention, except as may be recited in the claims accompanying this specification.

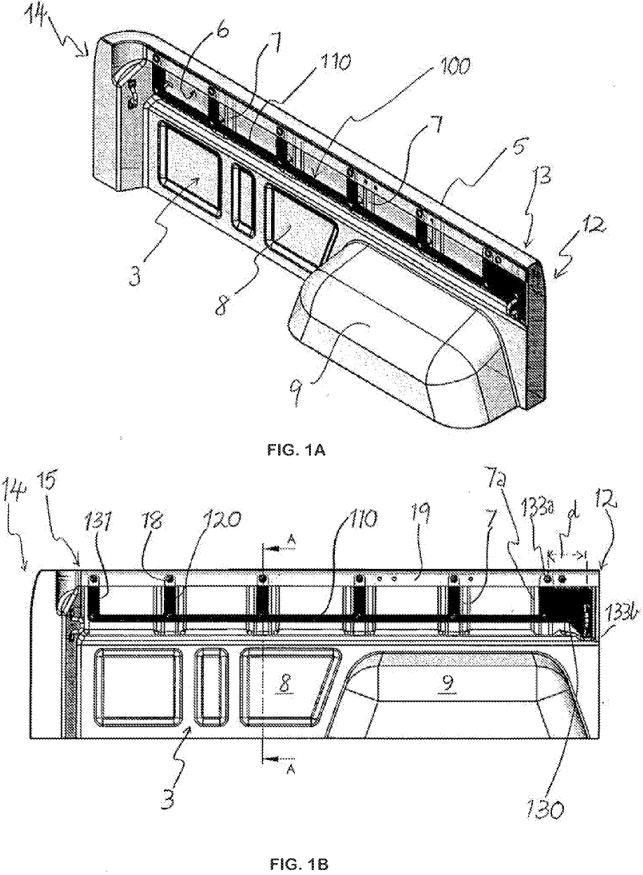

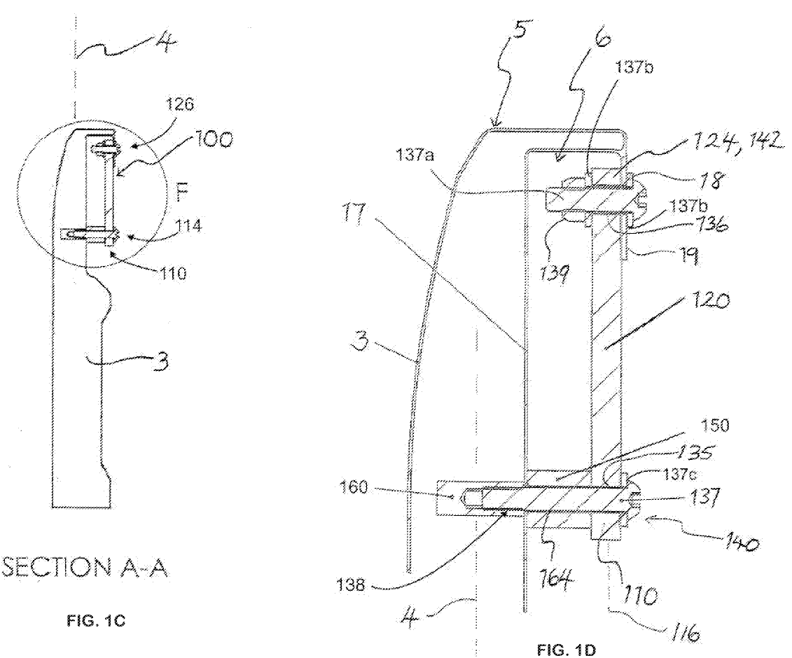

Referring to the drawings, there is shown a tie rail 100 for a utility vehicle having a tray with at least a first wall 3. The first wall 3 is adapted to extend substantially in a first plane 4 (see FIG. 1C). The first wall 3 of a typical utility vehicle 1 may have a first outer edge 5 defining an internal recess 6. The first wall 3 may have at least two vehicle structural substrates 7 adapted to extend substantially transversely relative to the alignment of the first outer edge 5. Each vehicle structural substrate 7 may be in the form of a reinforced column, a buttress, a bulwark, a structural pillar or a first wall reinforcing stud. Alternatively, if the vehicle does not have discrete pillars or studs or the like, the first wall 3 may be made of a strong frame or exoskeleton, or comprise sheet metal or another strong sheet material, that is sufficiently strong structurally to mount or otherwise support the tie rail 100.

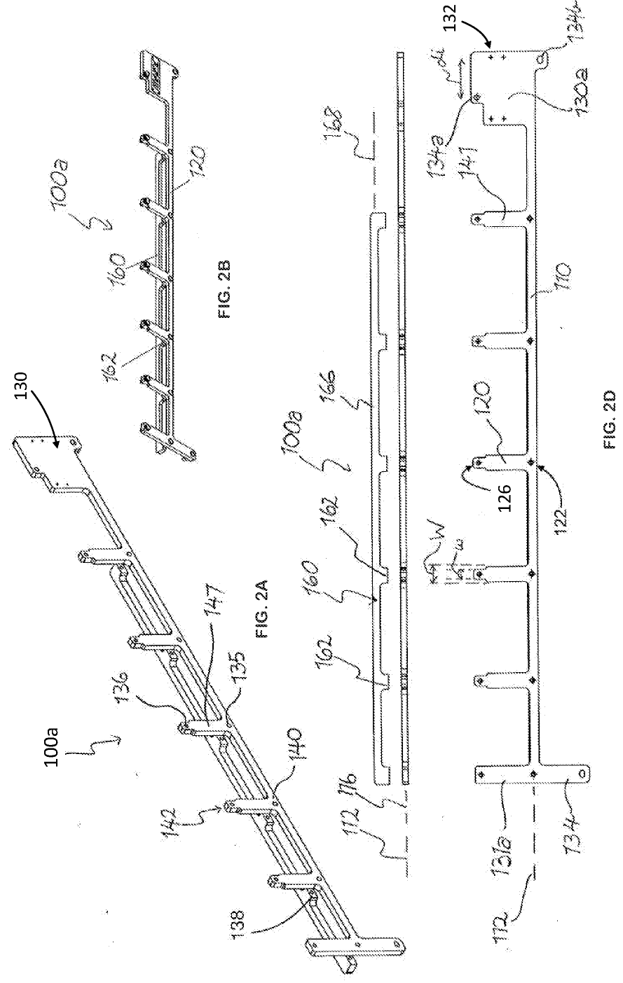

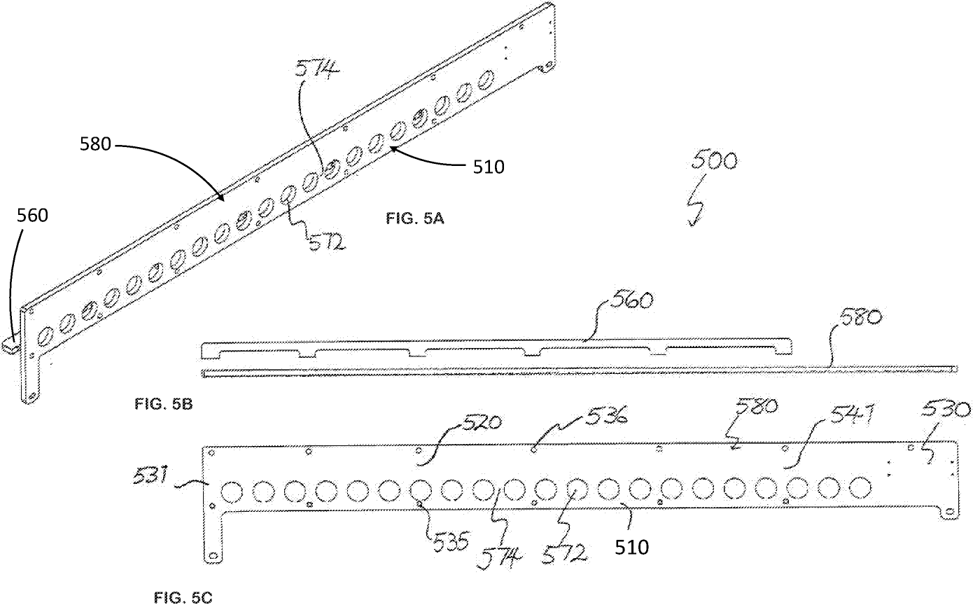

The tie rail 100 includes the first member 110 on which items, such as ropes, hooks and straps may be tied or otherwise attached. The first member 110 is substantially rigid and strong, elongate and continuous. The first member 110 may be in the form of a bar, beam or rod, as shown in FIGS. 1A - 4C. Alternatively, the first member 110 may be in the form of a rigid ribbon, strap or plate, that is cut out, stamped, cast or moulded into an elongate member. The first member 110 may form part of a plate, as shown in FIGS. 5A - 6C. When mounted on the first wall 3, the first member 110 is spaced from and extends substantially parallel to the first plane 4 and the first outer edge 5. The tie rail 100 also has at least two anchor sections 120 extending transversely to a longitudinal axis 112 (see FIGS. 2A-2D) of the first member 110.

The anchor sections 120 are preferably located at the ends of the first member 110. The anchor sections 120 are still more preferably located intermediate the length of the first member 110. The anchor sections 120 include at least two spaced anchor points 122 that are generally adapted to be vertically aligned in installation. Each anchor section 120 and each pair of anchor points 122 are each adapted to align with one of the vehicle structural substrates 7. Where the first wall 3 does not include discrete pillars or studs, the vehicle structural substrate 7 may be an arbitrary section of the first wall 3. For example, the first wall 3 may be comprised of a frame with no upright studs, or of sheet metal of sufficient strength and rigidity, such that any section of the first wall 3 is adequate to serve as the vehicle structural substrate 7.

The anchor sections 120 are preferably formed as a continuous unitary piece with the first member 110. The anchor sections 120 have an outer end 124 remote from the first member 110 that is adapted to be received by the internal recess 6. If the first wall 3 does not include a first recess, then the outer end 124 may be located near or adjacent an upper section of the first wall 3. The anchor sections 120 include an outer anchor point 126 at or near the outer end 124. The outer anchor point 126 is spaced from both the first member 110 and an internal anchor point 114 located on or in the first member 110.

The tie rail 100 further includes an end member 130 that is broad in shape, compared to the width of one of the anchor sections 120 in the direction of the longitudinal axis 112. The end member 130 is broad in shape in directions aligned with and transverse to the longitudinal axis 112 of the first member 110 along the first plane 4. The end member 130 is sufficiently broad to accommodate one or more, and preferably at least two, end anchor points 132. The at least two end anchor points 132 are preferably spaced from each other in the direction of the longitudinal axis 112 of the first member 110.

Referring particularly to FIGS. 2A-2D, there is shown a tie rail 100a with minor variations between the tie rail 100 of the first embodiment shown in FIGS. 1A-1D and the tie rail 100a of the second embodiment shown in FIGS. 2A-2D. In describing the tie rails 100,100a, the first wall 3 comprises a standard side wall of a utility vehicle (not shown) and has a front end 12 adapted to fit near or to abut a headboard of the utility tray (not shown) and a rear end 14 adapted to cooperate with a tail gate (not shown). The first wall 3 includes metal panelling 8, a wheel arch 9 toward the front end 12, and a plurality of vehicle structural substrates in the form of substantially upright pillars 7.

The tie rail 100 comprises a unitarily and integrally formed piece including the first member in the form of the linearly extending bar 110, that extends between the end member 130 which is in the form of a front-end member 130, and a rear end member 131, respectively located near the front and rear ends 12, 14, and a plurality of upwardly extending anchor sections in the form of upright arms 147 of the anchor sections 120.

The front-end member 130 is fastened to the first wall 3 by at least 2 anchor points 133a,b spaced by a distance d in the direction of the longitudinal axis 112. The front-end member 130 is substantially broader in the direction d than each of the anchor sections 120. The front-end member 130 is shaped to conform to a front portion of the first wall 3 between a front most pillar 7a and the front end 12.

As it will be noted in respect of subsequent embodiments third-sixth, the front-end member n30 (i.e. reference numbers 330, 430, 530 and/or 630) is variably shaped to conform to the specific front portion 13 to which the front-end member n30 is to be attached. Similarly, the rear end member n31 (i.e. reference numbers 331, 431, 531 and/or 631) varies according to a rear portion 15 to which it is to be attached and its shape is adapted to correspondingly conform to the rear portion 15.

In the first embodiment shown in FIGS. 1A-1D, the rear end member 131 is essentially identical in shape to each of the intermediary anchor sections 120, whereas, in the second embodiment shown in FIGS. 2A-2D, the front-end member 130a has a lower extension 134 that depends below the longitudinal axis 112. The front-end member 130a of the second embodiment also varies slightly, relative to the front-end member 130 of the first embodiment to provide options for first and second anchor points 134a, b spaced by a distance di. The spacing of anchor points 122, 132 are advantageously spaced as far apart as possible for each member 130, 130a, 131, 131a in both vertical and horizontal dimensions to optimise stability and rigidity of the structure of the tie rail 100.

The anchor sections 120 each comprise a base 140 through which there is centrally located a lower anchor point 135, the upwardly extending arm 147 and a narrow head 142 in which there is centrally located an upper anchor point 136. The anchor section 120 comprises continuous material between the base 140, through the arm 147 and the head 142. The head 142 corresponds to the outer end 124. The head 142 has a narrower width w than the width W of the arm 147. Each of the corner transitions between the base 140, the arm 147 and the head 142 are radiused to strengthen the joins and connections, and to minimise the risk of fatigue cracks or snag hazards.

As shown in FIGS. 1C-2D the base 140 includes an anchor fastener 137a extending outwardly and substantially horizontally through a washer 137c, through the base 140 at the lower anchor point 135, through a spacer 150, through a structural substrate 7 or the first wall 3 and into threaded hole 138 at 162 of the separate brace 160. The outer end 124 or head 142 includes the upper anchor point 136 which is positioned to be in registration with a corresponding fastener hole 18 formed in a downwardly depending flange 19 that together with the structural substrate 7 or first wall 3 and the first outer edge 5, defines the recess 6, to receive the upper anchor fastener 137a in the form of a threaded bolt, washers 137b and nut 139 combination, so that the outer end 124 and nut 139 sit behind the flange 19 in the recess 6.

The tie rail 100 may be provided with a plurality of spacers 150, each one corresponding to a lower anchor point 135. The spacers 150 are interposed between the first member 120 and the structural substrate 7 or the first wall 3. Each spacer 150 provides a gap between the first member 110 and the structural substrate 7 or first wall 3 for attaching hooks, straps or ropes etc. The spacers 150 are adapted to space the base 140 from the structural substrate 7 or first wall 3, such that the anchor sections 120 lie in a plane 116 that is substantially parallel to the first wall plane 4.

The spacers 150 are adapted to space the base 140 from the inner skin 17, such that the anchor sections 120 lie in a plane 116 that is substantially parallel to the first wall plane 4.

Referring to FIGS. 2A-2D, the second embodiment, tie rail 100a, includes a continuous, elongate element advantageously serving as a reinforcing brace 160 extending parallel to the longitudinal axis 112 and the anchor section planes 116. The brace 160 includes a plurality of equally spaced spacer elements 162 that provide a bulbous body surrounding corresponding spacer element apertures 164 to strengthen the brace 160 at the locations of the multiple apertures 164. Each aperture 164 is adapted to be in coaxial registration with a corresponding lower anchor point 135 and the bore of anchor plug 138. The brace 160 includes an elongate element 166 bridging the spacer elements 162 and extending between the rear end member 131 and the front most anchor section 141. The brace 160 is a unitarily formed element made from a unitary piece of material that is strong and resists flexing, compression and extension along a spacer longitudinal axis 168.

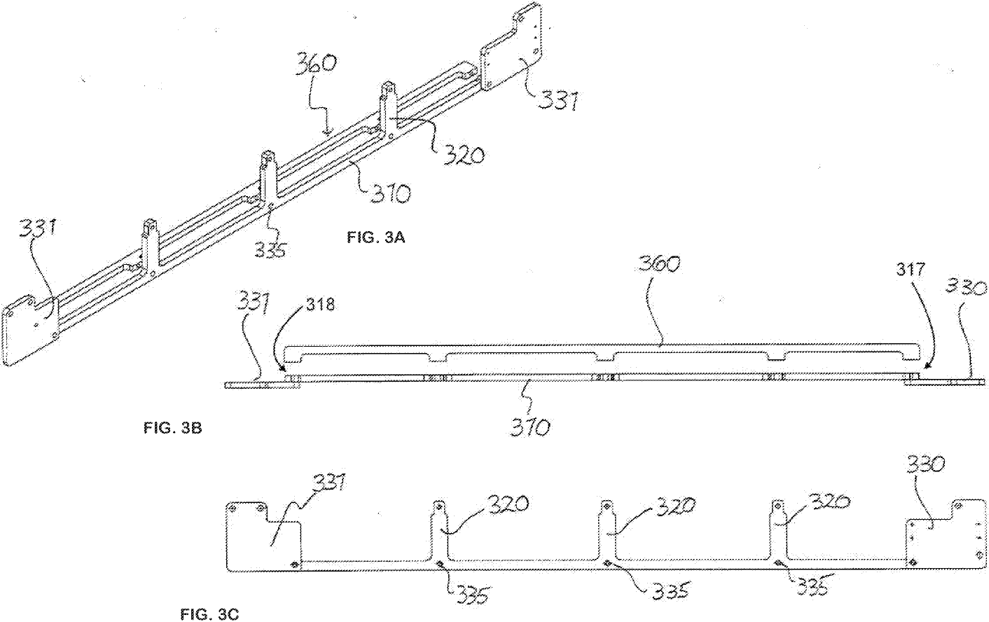

Referring to the third embodiment shown in FIGS. 3A-3C, similar features with respect to the first and second embodiments will be referred to using similar reference numbers. However, it is noted that, with reference to the plan view shown in FIG. 3B, the front and rear end members 330, 331 are separately formed relative to the first member 310 and the rear end member 331 comprises a broad plate similar to the front-end member 330. In this connection, the front and rear end members 330, 331 are optional, whereby the first member 310, anchor sections 320 and brace 360 are sufficient to constitute the tie rail 300 of the third embodiment without the additional front and rear end members 330, 331. However, the front and rear end members 330, 331 are advantageous to strengthen and reinforce the respective ends 317, 318 of the first member 310 where the first member 310 may be subjected to the greatest undistributed focussed flexing loads, these central anchor sections 320 and lower anchor points 335 being adapted, by their centralised positioning, to be somewhat protected from flexing loads that can be distributed either side of the anchor sections 320. Therefore, whilst the front-end rear sections 330, 331 are preferred where space on the first wall 3 permits, they may be optional and the third embodiment has utility without them.

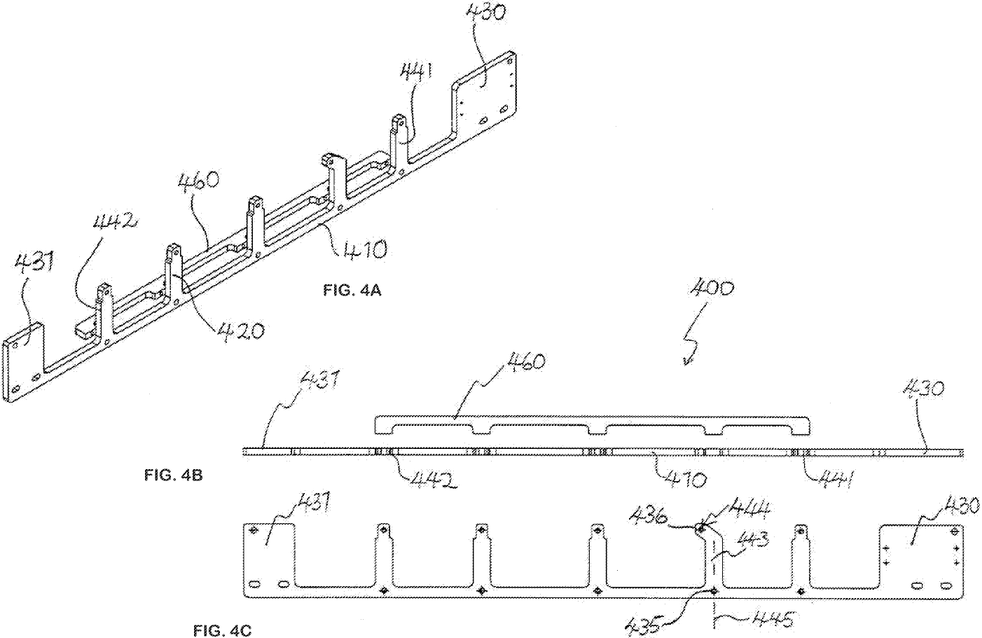

With reference to the fourth embodiment shown in FIGS. 4A-4C, the front and rear end members 430, 431 are formed as an integrally formed piece with the first member 410 and the rear end member 431 is substantially broader than the width W of the anchor sections 420. The brace 460 extends only between the front most 441 and rear most 442 anchor sections, whereas the first member 410 extends fore and aft beyond the front and rear locations of the front and rear anchor sections 441, 442 to the front and rear end members 430, 431.

At least one of the anchor sections, in this case the penultimate front anchor section 443, may have be an example where the upper anchor point 436 and its corresponding head 444 are offset relative to a general longitudinal axis 445 of the anchor section 420, for example where the vehicle structural substrate 7 for the location of the upper anchor point 436 is not linearly or vertically aligned relative to the lower anchor point 435.

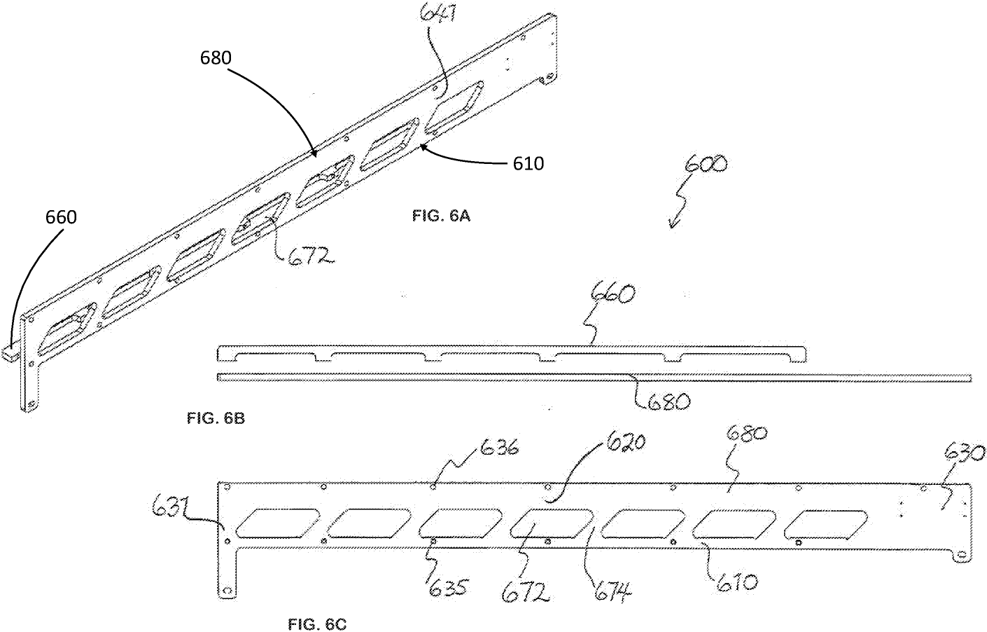

Referring now to the fifth and sixth embodiments shown in FIGS. 5A-6C, a tie rail 500, 600 is formed from a plate 570, 670, is ideally a metal plate such as stainless steel or Aluminium having an elongate rectangular shape. The anchor sections 520, 620 are defined between circular or trapezoidal cut outs 572, 672, although other geometric shapes, such as ellipses, triangles, rectangles and other polygonal shapes will be suitable. Preferably the cut outs 572, 672 are shaped as circles or tilted rectangles. In these embodiments, the anchor sections 520, 620 do not necessarily have continuous vertical structures uninterrupted by cut outs 572, 672. Instead, the collective bridges 574, 674 laterally defined between cut outs 572, 672 collectively provide the rigid structure for the tie rail 500, 600 between the lower and upper anchor points 635, 636, optionally vertically offset from the anchor points 435, 436.

The upper anchor points 536, 636 are connected by a continuous elongate second member 580, 680 that is vertically spaced and parallel to the first member 510, 610 and is continuous with the front and rear end members 530, 630, 531, 631. The overall tie rail 500, 600 structure comprising the components 510, 610, 574, 674, 580, 680, 530, 630, 531, 631 provides an extremely strong and rigid tie rail 500, 600 structure with excellent load distribution and defocusing of load around the first member 510, 610.

Furthermore, the tie rail 500, 600 includes a reinforcing brace 560, 660 similar to the brace n60 of the first to fourth embodiments, and extending between the rear end member 531, 631 and the front most anchor section 541, 641.

Any discrepancies in the reference numbering may be resolved by reference to a reference table or, secondarily, to the context in which the reference numeral is used.

Throughout the specification and claims the word “comprise” and its derivatives are intended to have an inclusive rather than exclusive meaning unless the contrary is expressly stated or the context requires otherwise. That is, the word “comprise” and its derivatives will be taken to indicate the inclusion of not only the listed components, steps or features that it directly references, but also other components, steps or features not specifically listed, unless the contrary is expressly stated or the context requires otherwise.

In this specification, “truss” means a structural lattice including at least two spaced beams extending parallel or extending at an acute angle relative to each other, the beams spanned by at least two struts, the lattice being a fixed structure in which the beams are rigidly fixed relative to each other. The beams are preferably rigid and capable of only minimal flexing.

In the present specification, terms such as “apparatus”, “means”, “device” and “member” may refer to singular or plural items and are terms intended to refer to a set of properties, functions or characteristics performed by one or more items or components having one or more parts. It is envisaged that where an “apparatus”, “means”, “device” or “member” or similar term is described as being a unitary object, then a functionally equivalent object having multiple components is considered to fall within the scope of the term, and similarly, where an “apparatus”, “assembly”, “means”, “device” or “member” is described as having multiple components, a functionally equivalent but unitary object is also considered to fall within the scope of the term, unless the contrary is expressly stated or the context requires otherwise. In the present specification, the phrase “and/or” refers to severally or any combination of the features. For example, the phrase “feature 1, feature 2 and/or feature 3” includes within its scope any one of the following combinations: Feature 1 or feature 2 or feature 3; feature 1 and feature 2 or feature 3; feature 1 or feature 2 and feature 3; feature 1 and feature 3 or feature 2; feature 1 and feature 2 and feature 3.

The meaning of descriptive, precise or absolute terms such as “flexed”, “normal”, “parallel”, “horizontal”, “vertical” or “fully” includes the preceding qualifier “substantially or almost”, unless the context or contrary is expressly indicated.

Qualifying relative terms, such as “relatively”, “sufficiently”, “near”, “almost” or “substantially”, may be taken to indicate a variation in an absolute value of between 0° and 10° or between 0% and 10%, relative to the absolute value. For example, “near horizontal” may be taken to mean any orientation between 0° and 10° relative to the horizontal.

Orientational terms used in the specification and claims such as vertical, horizontal, top, bottom, upper and lower are to be interpreted as relational and are based on the premise that the component, item, article, apparatus, device or instrument will usually be considered in a particular orientation, which will usually be apparent from the context, but in any case the lower most component is the first member or a tail flange of the outer end.

In the present specification, the term “integral” means formed of one body in a single process. In particular, the term “integrally formed” means formed of the one body without post-forming attachment of separately formed component parts. That is, “integrally formed” and the similar term “unitarily formed” mean formed in a single forming process and do not include post-forming attachment of component parts by means of fastener or other component fixing substances or methods.

The articles “a” and “an” are used herein to refer to one or to more than one (i.e. to at least one) of the grammatical object of the article. By way of example, “an element” means one element or more than one element.

It will be appreciated by those skilled in the art that many modifications and variations may be made to the methods of the invention described herein without departing from the spirit and scope of the invention. The features and components of each of the embodiments of the invention described in the detailed description and/or depicted in the accompanying drawings may be interchangeable as required, with regard to functional equivalency and compatibility. A feature or component described with reference to one but not all embodiments, if functionally and dimensionally compatible as an addition with another embodiment herein described, or substitutable with a corresponding feature or component of that other embodiment in relation to which it has not been expressly described, should be read as a potential addition or substitution to that other embodiment and as being within the scope of the invention. Furthermore, in considering a feature or component that is described in relation a particular embodiment but may be omitted from the embodiment without losing the functionality characterising the invention and without departing from the scope of the invention, unless the context and expressions used in describing the embodiment imputes that the feature or component is essential to the invention as broadly described, the omittable feature or component may be read as not being included in the embodiment.

1. A tie rail for a utility vehicle having a tray with at least a first wall, the first wall:
i. being adapted to extend substantially in a first plane;
ii. having a first outer edge defining an internal recess; and
ii. having at least two vehicle structural substrates adapted to extend substantially transversely to the first outer edge,
the tie rail comprising:
A. a substantially rigid and strong elongate and continuous first member on which items may be tied, the first member being spaced from and extending substantially parallel to the first plane and the first outer edge;
B. at least two anchor sections extending transversely to a longitudinal axis of the first member, the anchor sections:
i. each being adapted to align with a vehicle structural substrate;
ii. are formed as a continuous unitary piece with the first member;
iii. have an outer end remote from the first member that is adapted to be received by the internal recess;
iv. include an outer anchor point at or near the outer end, the outer anchor point being spaced from both:
the first member; and
an internal anchor point located on or in the first member; and
C. an end member that is broader in shape, compared to the anchor sections, along the first plane and accommodates one or more end anchor points.

2. The tie rail as claimed in claim 1, wherein the first member is a rod or bar.

3. The tie rail as claimed in claim 1, further including a brace aligned parallel to the first member and adapted to strengthen the first rail by defocussing and distributing loads applied to the first member.

4. The tie rail as claimed in claim 1, further including a second member vertically spaced from, aligned parallel to the first member and extending linearly so that a longitudinal axis of the second member intersects each outer anchor point of each anchor section.

5. The tie rail as claimed in claim 4, wherein the first and second members are integrally formed and the material from which they are formed is continuous with the end member.

6. The tie rail as claimed in claim 5, wherein the end member is a front end member that is sufficiently broad to accommodate at least two end anchor points that are spaced from each other in the direction of the longitudinal axis.

7. The tie rail as claimed in claim 6, wherein the front-end member is adapted to be fastened to the first wall by the end anchor points in the form of at least 2 anchor points that are spaced by a distance d in the direction of the longitudinal axis.

8. The tie rail as claimed in claim 7, wherein the front-end member is substantially broader in the direction d than each of the anchor sections and is shaped to conform to a front portion of the first wall between a front most pillar and a front end of the vehicle.

9. The tie rail as claimed in claim 6, further including a rear end member adapted to be attached at or near to a rear end of the vehicle and essentially identical in shape to each of the anchor sections, being intermediary anchor sections located between the front and rear end members.

10. The tie rail as claimed in claim 9, wherein the front-end member has a lower extension that depends below the longitudinal axis.

11. The tie rail as claimed in claim 9, wherein the intermediary anchor sections each comprise:
a base through which there is centrally located a lower anchor point;
an upwardly extending arm; and
a narrow head in which there is centrally located an upper anchor point.

12. The tie rail as claimed in claim 11, wherein the intermediary anchor sections comprise continuous material between the base, through the upright arm and the head.

13. The tie rail as claimed in claim 11, wherein the head corresponds to the outer end and has a narrower width w than the width W of the upright arm.

14. The tie rail as claimed in claim 1, further including a plurality of spacers, each one corresponding to a lower anchor point, the spacers being interposed between the first member and the structural substrate or the first wall.

15. The tie rail as claimed in claim 14, wherein each spacer provides a gap between the first member and the structural substrate or the first wall for attaching hooks, straps or ropes.

16. The tie rail as claimed in claim 14, wherein each spacer is adapted to space the base from the structural substrate or the first wall, such that the anchor sections lie in an anchor section plane that is substantially parallel to the first wall plane.

17. The tie rail as claimed in claim 1, further including a continuous, elongate element in the form of a reinforcing brace extending parallel to the longitudinal axis and a plane in which the anchor sections lie.

18. The tie rail as claimed in claim 17, wherein the brace includes a plurality of equally spaced spacer elements that provide a bulbous body surrounding corresponding spacer element apertures to strengthen the brace at locations of multiple apertures.

19. The tie rail as claimed in claim 18, wherein each aperture is adapted to be in coaxial registration with a corresponding lower anchor point and a bore of an anchor plug.

20. The tie rail as claimed in claim 18, wherein the brace includes an elongate element bridging the spacer elements and extending between a rear end member and a front most anchor section.

21. The tie rail as claimed in claim 20, wherein the brace is a unitarily formed element made from a unitary piece of material that is strong and resists flexing, compression and extension along a spacer longitudinal axis.
